(19) United States
(12) Patent Application Publication
(10) Pub. No.: US 2015/0339631 A1
(43) Pub. Date: Nov. 26, 2015

(54) GoGig: A Mobile Platform that Matches Job Seekers with Job Recruiters Based on Desired Job Characteristics and Geo-location of the Mobile Device

(71) Applicant: Christopher Michael Hodges, Ft. Lauderdale, FL (US)

(72) Inventor: Christopher Michael Hodges, Ft. Lauderdale, FL (US)

(21) Appl. No.: 14/716,078

(22) Filed: May 19, 2015

Related U.S. Application Data
(60) Provisional application No. 62/001,247, filed on May 21, 2014.

(51) Int. Cl. G06Q 10/10; G06Q 50/00; H04L 29/08

(52) U.S. Cl. CPC G06Q 10/1053; H04L 67/306; H04L 67/02; G06Q 50/01

(57) ABSTRACT

This invention connects job seekers and job recruiters, online and through mobile and tablet applications, based on mutually sought after characteristics and geographic location. Job seekers will create profiles and search for jobs posted that match theft profiles while simultaneously reveal to job recruiters each job seeker's identifying information, work and education history, skills, and personality. Job recruiter can also post available jobs to which job seekers can apply or search out job seekers based on the content of job seekers' profiles. Results are available to job recruiters either by ranking the job seekers in order of percentage match or by showing the job seekers on a map to determine geographic distance from the available job. Upon a mutual match of a job recruiter and a job seeker, the users will be able to communicate online and through the application and thereafter set up an interview

This nonprovisional application claims benefit to provisional application No. 62/001,247, filed May 21, 2014.

### BACKGROUND OF THE INVENTION

Job recruiters have used job boards to post job openings to which any job seeker who finds the posting could apply. Typically, job recruiters post a job opening and are inundated with endless applications from job seekers offering whatever information they see fit to provide. Applications to jobs posted on job boards therefore vary in content and are subjective. In addition, when provided with only the information job recruiters see fit to provide in a job posting on a job board, job seekers scour every entry on job boards and apply to countless open jobs without any indication that the job will be a good fit for the job seeker. Time is unnecessarily expended by both job seekers and job recruiters in this current process where job recruiters are forced to sift through endless applications without any guarantee that any job seeker would fit the open job, and job seekers are forced to cast a wide net and apply blindly, hoping something might stick. Job boards are inefficient for its two largest users, job recruiters and job seekers. GoGig is not a job board. Instead, GoGig brings to job recruiters and job seekers techniques to facilitate a meaningful connection between job recruiters and job seekers with full functionality on both web and mobile devices.

### BRIEF SUMMARY OF THE INVENTION

GoGig provides a technology product that is available to two sides of the hiring and recruiting continuum: job recruiters and job seekers. GoGig has the same functionality online and on mobile and tablet devices to provide a mobile professional network that confidentially matches job recruiters to candidate job seekers based on four components: candidate work, education, and skills history; everything the candidate wants out of his next career move; candidate personality; and the geographical location of the areas in which the candidates want to work. GoGig uses these four components to match job seekers with available jobs that best fit these four components and to match job recruiters trying to fill available jobs with job seekers who best fit these four components.

Specifically, GoGig gives job recruiters access to its network of job seekers to facilitate matches between the job recruiters to the job seekers who match the requirements of the available job. Job recruiters can use GoGig to create searches to find candidate job seekers who match the searched for criteria. Unlike the use of job boards, GoGig provides job recruiters with a pool of job seeker profiles ready to be viewed whenever the job recruiter chooses to run a search. Alternatively, job recruiters can upload specific job postings and run searches for candidate job seekers whose profiles match directly to those postings.

Job recruiters receive results of only the matching job seeker profiles for the most relevant candidates to the available jobs, forgoing the previous process of reviewing and analyzing endless unfiltered job applications for the available job. With GoGig, the matched job seeker profiles are displayed to job recruiters in two forms between which the job recruiter can toggle based on what the job recruiter values more, the closest geographically located job seeker or the job seeker with the highest percentage match to the searched for criteria. Regardless of the method for viewing results, when a job recruiter is interested in a job seeker's profile, the job recruiter can invite the job seeker to apply for the available job and enable communication between the users directly through the GoGig mobile application or webpage interface.

For job seekers, GoGig is built to accommodate both active and passive candidates on its network. Active job seekers can search to find available jobs posted that match their profiles to which they can apply. Previous processes would have instead had job seekers subjectively determining whether an available job found on traditional job boards would be a good fit. GoGig filters out jobs that do not match the job seeker's profile. Passive job seekers can create a profile and await an invite to apply from a job recruiter who runs a search and is interested in the job seeker's profile. Job seekers simply download the GoGig mobile or tablet application or access the online webpage and supply GoGig with information on the four profile components. GoGig is advantageous for all users. Job Recruiters will always have access to a feature called the GoGig Dashboard that provides valuable statistics and insight into how GoGig is increasing the return of investment for the job recruiter. All information relative as to use of GoGig can be tracked, downloaded, and reported. Similarly, job seekers can view statistics relative to their individual GoGig networking results. GoGig provides job seekers with valuable updates and analysis on the reception of their online job seeker profiles with job recruiters based on desired job areas. GoGig also provides job seekers tips on how to improve their profiles and overall results.

### BRIEF DESCRIPTION OF DRAWINGS

FIG. 1 depicts the identifying information extracted from a job seeker's LinkedIn profile or that the Job Seeker manually enters and self-reports to create his online job seeker profile.

FIG. 2 depicts the information a job seeker will manually report as to the desired job characteristics and work environment to create his online job seeker profile.

### DETAILED DESCRIPTION OF THE INVENTION

This business process provides a service that will be available with the same functionality on both webpages as well as mobile and tablet applications. The services and interfaces will be tailored depending on the type of client using the service. The two types of client include those seeking a job, or “Job Seekers,” and those recruiting for jobs, or “Job Recruiters.” The type of client will also determine what information is collected to permit the matches. These services will be provided at a cost to be determined by market forces and demand.

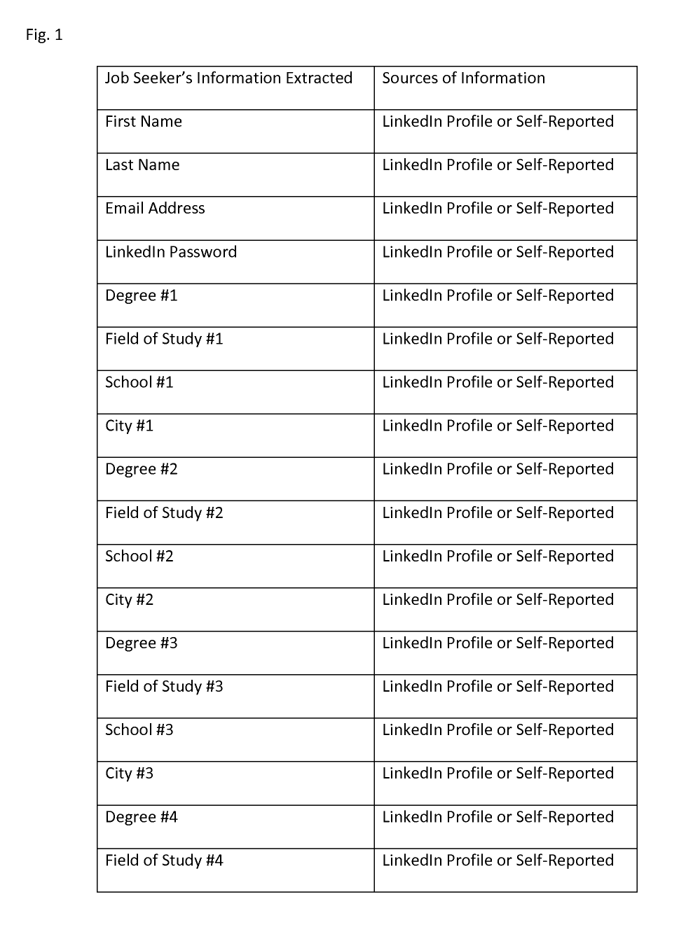

The profile for a Job Seeker will be created integrating information from four distinct sources. FIG. 1. First, information will be extracted from the Job Seeker's Linkedln profile if he has such a profile. The information includes the Job Seeker's identifying information that will be kept confidential. This identifying information includes the Job Seeker's first and last name, email address, and password. The information will also include the Job Seeker's work and education history that will be visible on the Job Seeker's public profile. The Job Seeker will also have the option to have his Linkedln profile picture extracted and included in his public profile. If a Job Seeker does not have a Linkedln profile, he can utilize a mobile-optimized account created that allows him to manually enter all the information extracted from the Linkedln profile. The same information can therefore come from two sources, Linkedln or self-reported from the Job Seeker.

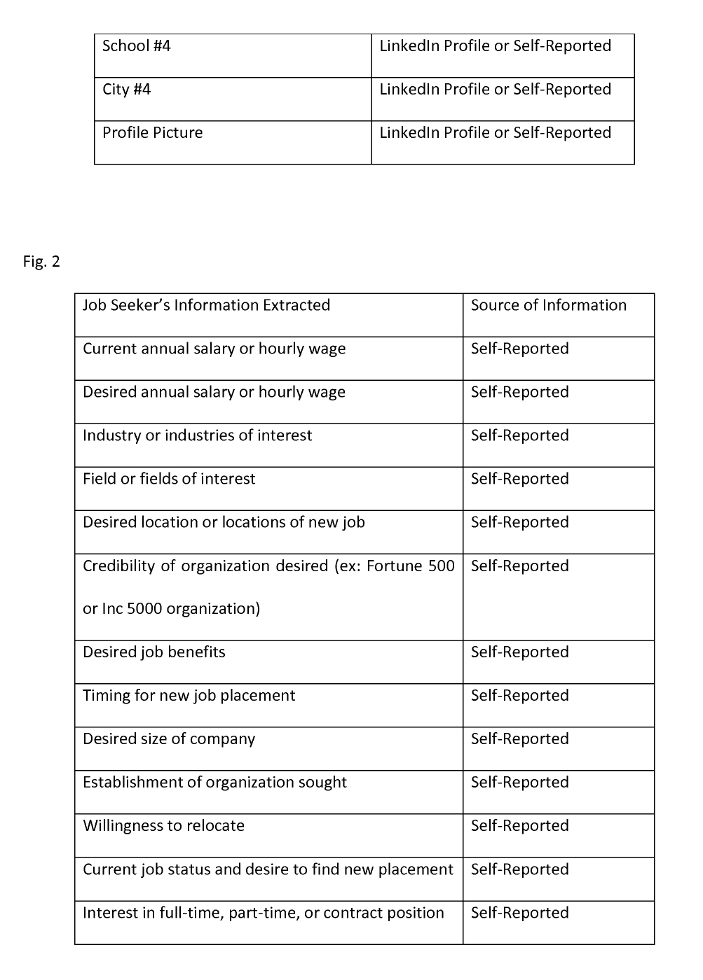

FIG. 2. Second, the Job Seeker will provide information on the job characteristics and work environment he desires. This will include reporting of current annual salary or hourly wage and desired annual salary or hourly wage; industry or industries of interest; field or fields of interest; desired location or locations of new job; credibility of organization desired (ex: Fortune 500 or Inc 5000 organization); desired job benefits; timing for new job placement; desired size of company; establishment of organization sought; willingness to relocate; current job status and desire to find new placement; and interest in full-time, part-time, or contract position. Third, the Job Seeker will choose, from all the job skills listed in FIG. 3, the “top 3” that best describe him. The three chosen will be displayed in the Job Seeker's public profile. Next, the Job Seeker will self-report job-specific skills that will also be displayed on the Job Seeker's public profile.

Finally, the Job Seeker will manually enter information that provides a basis for “Personality Matching” between the Job Seeker and Job Recruiter. The “Personality Matching” is based on the Job Seeker's response to eight (8) scenarios. In each scenario, the Job Seeker must decide between two options. The answers to each scenario are interpreted and place the Job Seeker on “The Gig Personality Meter.” The Job Seeker must then answer two (2) scenarios tailored to determining the Job Seeker's aggressiveness, the answers to which are interpreted and reflected in the public Job Seeker profile.

Though all this information will be made available in a profile accessible by Job Recruiters, the identities of the Job Seekers will remain confidential. Personal identifying information as to the Job Seeker will not be included in the profile generated. Job seekers can expect to be matched with recruiters who find interest in their confidential profiles based on recruiter search queries. The Job Recruiter will create either a search query for a candidate that they desire or post a job description for an available job- both of which integrate information based on what the Job Recruiter desires out of the sought after Job Seeker. Regardless of which method the Job Recruiter uses, GoGig will return matched results to either the Job Recruiter's search query or job description posted. This information will only come from one source, the Job Recruiter himself.

The Job Recruiter will provide information as to the work environment, company demographics, and characteristics. The Job Recruiter will then provide specifics as to the position being offered that corresponds to the information submitted by the Job Seeker as discussed above and shown in FIG. 2, including annual salary or hourly wage, industry or industries involved, field or fields involved, position location, relocation details, credibility of the organization (ex: Fortune 500 or Inc 5000 organization), job benefits, timing of business need for new talent, company and division size, and specifics as to whether the job is full-time, part-time, or contracted. Finally, the Job Recruiter will provide information as to the candidate sought, including work history, industry history, education requirements, current status in their job networking process, personality desired, on-the-job skills, etc.

Once a Job Seeker profile is completed, a search is performed to see if his profile matches any posted jobs. The Job Seeker can choose to save a particular match for future review by clicking an associated “Like” icon with the job posted. This would keep the posted job saved for access at a future time. If the Job Seeker is not able to be matched to any posted job at any given time, his profile becomes public and searchable by Job Recruiters.

Once the Job Recruiter has created a profile, he will then be matched to Job Seeker profiles that match with the criteria specified in the Job Recruiters' search in two ways. First, the Job Recruiter will be able to see Job Seeker profiles in a list style where applicants are ranked by their percentage of matching to what the Job Recruiter is seeking. The Job Recruiter will also be able to see how many candidates match the criteria for the position posted regardless of location. Second, the Job Recruiter will also be able to see a map-style format where the Job Seekers are placed based on geographical distance from the available job with the percentage matching to what the Job Recruiter is seeking also listed.

The Job Recruiter will be able to switch back and forth between both views of the results: the list of Job Seekers based on percentage matching or the map of Job Seekers. This back and forth capability, or toggle function, permits the Job Recruiter to see where each Job Seeker is located relative to geographic location of the job for which the Job Recruiter is searching. The Job Recruiter can also use distance thresholds or radius limits on the search results generated. These thresholds or limits can be altered at any time by the Job Recruiter.

Once the Job Recruiter has created a profile, he will then be matched to Job Seeker profiles that match with the criteria specified in the Job Recruiters' search in two ways, as described above. The Job Recruiter is then able to see the Job Seekers' public profiles that are produced. If the Job Recruiter views a particular Job Seeker profile of interest, the Job Recruiter has three options on what to do with the profile, each of which will appear for selection on each Job Seeker profile. The three options, described below, will appear on the profile as “NO” or “SAVE” or YES”.

“NO”—if the Job Recruiter does not find a Job Seeker desirable, he would select “NO” and never see this particular candidate again in any search query built on their Job Recruiter profile. “SAVE”—if the Job Recruiter is unsure about the Job Seeker's fit with the particular position posted or wants to keep the Job Seeker's profile handy for another position in the future, he would select “SAVE” and the Job Seeker's profile would be kept in an accessible custom-built folder for future viewing.

“YES”—if the Job Recruiter does find a Job Seeker desirable for the posted position, he would select “YES” and enable the service's chat functionality where in a chat window appears and the Job Seeker is then able to speak with the Job Recruiter if he so chooses. The chat window maintains the confidentiality of Job Seeker's identity. Job Seeker may then respond if he so chooses and continue through job interview if it is offered.

If the Job Recruiter and Job Seeker agree to schedule an interview, each client can utilize GoGig's “Interview Scheduling” feature that can be selected in the chat window. This feature will prompt both the Job Recruiter and the Job Seeker for the date and time of the interview. The chosen date and time for the interview can then be synced to the Job Seeker's and Job Recruiter's respective calendars built into same device on which each has accessed GoGig, whether a phone, tablet, computer, or other means of accessing GoGig developed in the future. The Job Seeker can also pay a premium for additional services to aid in the matching process with Job Recruiters. One such service is called HireFeed and provides an up-to-date feed of specific job descriptions submitted by Job Recruiters that meets the Job Seeker's career preferences. HireFeed matches the Job Seeker to postings based on job characteristics. These job descriptions appear in the Job Seekers' profiles if and only if they match their public profiles, interests, requirements, etc. The Job Seeker can then use a “One-Click Apply” feature to apply for the open position by just clicking on the icon. The Job Seeker's public profile is then placed in the Job Recruiter's priority HireFeed match list.

If the Job Seeker comes across an open position that he wishes to access at a later time and does not want to initially use the “One-Click Apply” feature for the open position, the Job Seeker can utilize the “Like” feature and save the open position for future access.

It will be appreciated that variations of the above-disclosed and other features and functions, or alternatives thereof, may be desirable and combined into many other different systems or applications. Also, that various presently unforeseen or unanticipated alternatives, modifications, variations or improvements therein may be subsequently made by those skilled in the art which are also intended to be encompassed by the above description. Where methods and steps described above indicate certain events occurring in certain order, those of ordinary skill in the art having the benefit of this specification would recognize that the ordering of certain steps may be modified to be performed in different orders and/or in concurrently, and that such modifications are in accordance with the variations of the invention. Thus, the methods illustrated are not intended to be limited to a particular sequential order, particularly in instances in which certain steps may or may not be performed or may be performed simultaneously. In addition, embodiments of services, both basic and premium, are intended to exemplify alternatives, modifications, and equivalents that may fall within the scope of this specification.

1. A method for filling job roles, said method comprising the steps of:
a job seeker creating an online job seeker profile;
a job recruiter posting an online description of an available job to search job seekers' profiles that match the description of the available job or the job recruiter manually entering search criteria of desired job seekers' profiles for the available job
the job seeker receiving a list of the available jobs posted online by job recruiters that match the online job seeker's profile;
the job recruiter conducting an online search and the online search yielding search results of job seekers' online profiles with an associated percentage match of each profile either to the online description of the available job or the manually entered search criteria of desired job seekers' profiles for the available job; and
the job recruiter enabling online communication between the job recruiter and the job seeker.

2. The method of claim 1 wherein the step of the job seeker creating the online job seeker profile includes the step of disclosing the job seeker's identifying information, education and work history, certificates and degrees obtained, and photograph.

3. The method of claim 1 wherein the step of the job seeker creating the online job seeker profile includes the step of disclosing desired work environment and job characteristics, current annual salary or hourly wage, desired available job annual salary or hourly wage, industry or industries of interest, field or fields of interest, desired available job location, desired credibility and establishment of desired job, desired job benefits, timing for start date of available job, desired company size, willingness to relocate for available job, current employment status and desire to find new placement, and interest in available jobs with either full-time, part-time, or contractual.

4. The method of claim 1 wherein the step of the job seeker creating the online job seeker profile includes the step of disclosing job skills that describe the job seeker, where said job skills are both chosen from a provided online list and manually entered online by the job seeker.

5. The method of claim 1 wherein the step of the job seeker creating the online job seeker profile includes the step of providing answers to ten scenarios intended to assess the job seeker's personality and aggressiveness.

6. The method of claim 1 wherein the step of the job recruiter posting a description of the available job includes the step of disclosing work environment, company demographics and characteristics, annual salary or hourly wage of the available job, industry or industries involved in the available job, field or fields involved in the available job, position location of the available job, relocation details for the available job, credibility of the organization, job benefits, timing of the job seeker's start date, company and division size, and whether the available job is full-time, part time, or contractual.

7. The method of claim 1 wherein the step of the job recruiter posting a description of the available job includes the step of disclosing characteristics of the desired job seeker sought that relate to work history, industry history, education requirements, personality desired, and job skills.

8. The method of claim 1 further comprising the step where upon the job seeker's receipt of the list of available job roles posted online by job recruiters that match the online job seeker's profile, the job seeker can choose to either submit the online job seeker profile for consideration by the job recruiter of any one of the available jobs from the list of available jobs or save any one of the available jobs from the list of available jobs for future review.

9. The method of claim 1 further comprising the step where upon the job seeker's receipt of the list of available job roles posted online by job recruiters that match the online job seeker's profile, the job seeker receiving an up-to-date feed listing specific available jobs posted online by job recruiters that match the online job seeker's profile based on the description of the available job.

10. The method of claim 8 further comprising the step where upon the job seeker choosing to submit the online job seeker profile for consideration by the job recruiter for any one of the available jobs from the list of available jobs, the job recruiter choosing to accept the job seeker profile for consideration and enabling online communication between the job recruiter and the job seeker.

11. The method of claim 1 further comprising the step where upon the job recruiter's online search yielding search results of job seekers' profiles, the job recruiter alternatively viewing said search results either as a list of job seeker profiles ranked by the percentage of matching to what the job recruiter is seeking or as points on a map representing the geographical location of each job seeker with the percentage of matching.

12. The method of claim 1 further comprising the step where upon the job recruiter's online search yielding search results of job seekers' profiles, the job recruiter selecting an individual job seeker profile to preclude from inclusion in future search results the job recruiter obtains.

13. The method of claim 1 further comprising the step where upon the job recruiter's online search yielding search results of job seekers' profiles, the job recruiter selecting an individual job seeker profile to save for inclusion in future search results the job recruiter obtains.

14. The method of claim 1 further comprising the step where upon the job recruiter's online search yielding search results of job seekers' profiles, the job recruiter selecting an individual job seeker profile to invite the job seeker to submit his online job seeker profile for consideration of the available job and enabling online communication between the job recruiter. and the job seeker.

15. The method of claim 1 further comprising the step where upon the job recruiter enabling online communication between the job recruiter and the job seeker, the job recruiter and the job seeker scheduling a date and time for the job seeker to be interviewed for the available job.
